(19) United States
(12) Patent Application Publication
(10) Pub. No.: US 2007/0157837 A1
(43) Pub. Date: Jul. 12, 2007

(54) Method and apparatus for inking a lens

(75) Inventor: Min-Che Li, Taichung City (TW)

Correspondence Address: BANGER SHIA, 204 CANYON CREEK, VICTORIA, TX, 77901, US

(73) Assignee: LARGAN PRECISION CO., LTD

(21) Appl. No.: 11/323,003

(22) Filed: Dec. 29, 2005

(51) Int. Cl. B41F 33/00

(52) U.S. Cl. 101/483

(57) ABSTRACT

A method and apparatus for applying ink to the inactive area of a lens, the method comprises the steps of: A, positioning lens; B, preparing stamping member; C, coating and inking by moving the stamping member linearly; D, retracting the stamping member; and E, taking out the lens. The apparatus comprises a stamping member and a positioning member. The stamping member moves linearly back and forth relative to the positioning member, on the surface of the stamping member is formed an inking surface coated with ink. The shape, the area, the location and the angle of the inking surface fit the inactive area of the lens to be inked. The inking surface of the stamping member can contact the inactive area of the lens, so as to enable the inactive area to be fully coated with ink.

### BACKGROUND OF THE INVENTION

1. Field of the Invention

The present invention relates to a method and an apparatus for inking a lens, which includes five steps for coating ink on the inactive area of the optical lens, and uses a stamping member to perform a quick inking operation to the inactive area of the lens.

2. Description of the Prior Art

The application scope of the modern image taking lens is expanding continuously. However, to comply with the requirement of miniaturizing the solid image sensor and the image taking lens as well as improving the performance thereof, the apparatus and the technology for lens inking also need to be improved in terms of production efficiency, precision, and assembly complexity. Therefore, along with the popularization of the photographic mobile phone the research and development in terms of inking method and apparatus are becoming more and more urgent. Hence, how to develop a more effective lens inking method has become an important consideration of the manufacturer.

Referring to FIGS. 1 and 2, a conventional lens inking method and apparatus are illustrated, the method includes the following steps:

1, positioning lens: positioning a lens 10 on a positioning device 11, and making the inactive area 101 around the periphery of the lens 10 protrude out of the positioning device 11;

2, rotating the positioning device and the lens: making the lens 10 rotate along with the positioning device 11;

3, preparing inking member: filling an inking member 12 with ink;

4, inking: applying ink to the inactive area 101 of the lens 10 by using the inking member 12;

5, taking out the lens: taking the inked lens 10 off the positioning device 11.

The abovementioned lens inking technology and the apparatus still have the following problems:

First, due to the conventional technology makes the lens 10 rotate along with the positioning device 11, then the inking member 12 can move along the periphery of the lens 10 for inking the inactive area 101. However, nowadays the existing lens are various in shapes (non-axial symmetry inactive area, non-outer periphery inactive area), and have many designs in terms of how they are assembled, not all various lenses can be inked perfectly by the use of positioning device 11.

Second, the conventional technology still partially depends on manpower, every piece of lens needs to be rotated and inked respectively, only one piece of lens 10 can be inked at a time, as a result, the inking process is less efficient and unsuitable for mass production.

Third, when applying ink to the inactive area 101 along the periphery of the lens 10, the inking member 12 is unable to coating the ink accurately with the predetermined scope, because the rotation of the positioning device 11 will cause instability of the inking operation, and the inking operation is very likely to cause error.

The present invention has arisen to mitigate and/or obviate the afore-described disadvantages.

### SUMMARY OF THE INVENTION

To solve the aforementioned problems, the inventor of this invention, on the basis of the accumulated experience and skills associated with the optical lens field, develops a lens inking method and apparatus that is simply structured, low coasted, high precision and suitable for mass production.

The method for inking a lens comprises the steps of:

A, positioning lens: positioning a lens on a positioning member, and making an inactive area of the lens protrudes out of the positioning member;

B, preparing stamping member: forming an inking surface coated with ink on a surface of the stamping member;

C, coating and inking by moving the stamping member linearly: moving the stamping member linearly back and forth with respect to the lens on the positioning member, and making the inking surface contact the inactive area of the lens, so as to apply the ink on the inking surface to the inactive area of the lens;

D, retracting the stamping member: moving the stamping member back to its original position; and

E, taking out the lens: taking the lens off the positioning member.

The primary objective of the present invention is to provide a method and apparatus for inking a lens that can improve the production efficiency and reduce the cost.

The present invention operates the steps of: A, positioning lens; B, preparing stamping member; C, coating and inking by moving the stamping member linearly; D, retracting the stamping member; and E, taking out the lens. Utilizing the abovementioned five steps, the present invention can effectively reduce the original manual operation time, it can create a high efficient stamping effect on the basis of quick inking operation. Furthermore, due to the shape, the area, the location and the angle of the inking surface all fit the inactive area of the lens to be inked very well, it can achieve a very good and accurate inked edge.

The secondary objective of the present invention is to provide a method and apparatus for inking a lens that is suitable for mass production.

The present invention mainly utilizes the step C of coating and inking by moving the stamping member linearly, such technology can enable a plurality of lenses to be inked synchronously. Therefore, it satisfies the requirement of mass production, effectively reducing the cost while improving the production efficiency.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a block diagram of illustrating conventional lens inking steps;

FIG. 2 is an operational view of illustrating how to apply ink to the inactive area of a lens;

FIG. 3 is a block diagram of illustrating lens inking steps in accordance with the present invention;

FIG. 4 is an operational view in accordance with the present invention, of illustrating the step A: positioning the lens;

FIG. 5 is an operational view in accordance with the present invention, of illustrating the step C of coating and inking by moving the stamping member linearly;

FIG. 6 is an operational view in accordance with the present invention, of illustrating the step E of taking out the lens;

FIG. 7 is an illustrative view of showing a second embodiment of the present invention; and

FIG. 8 is an illustrative view of showing a third embodiment of the present invention.

### DETAILED DESCRIPTION OF THE PREFERRED EMBODIMENTS

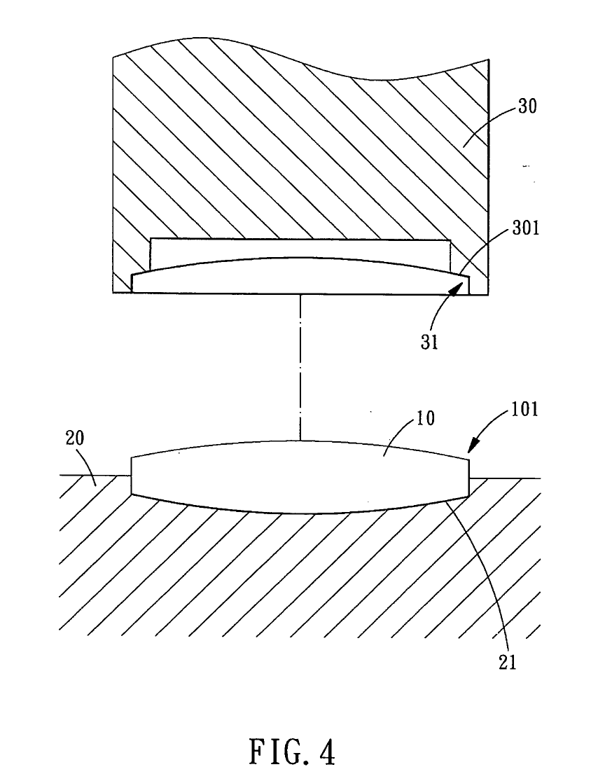

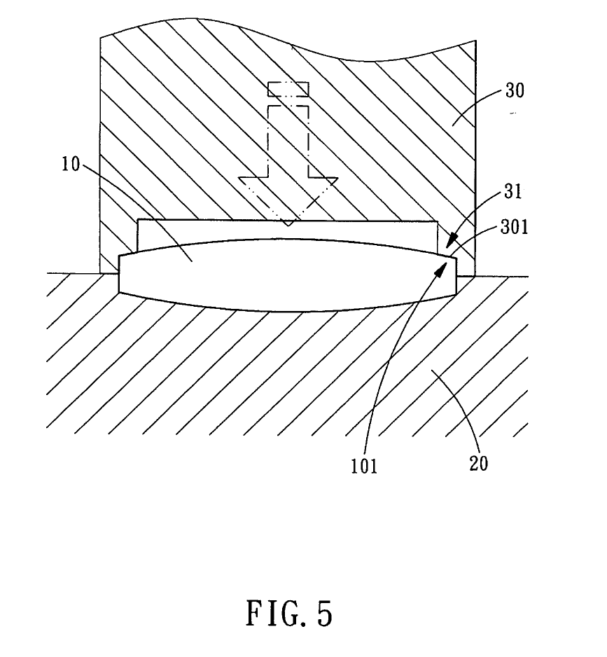

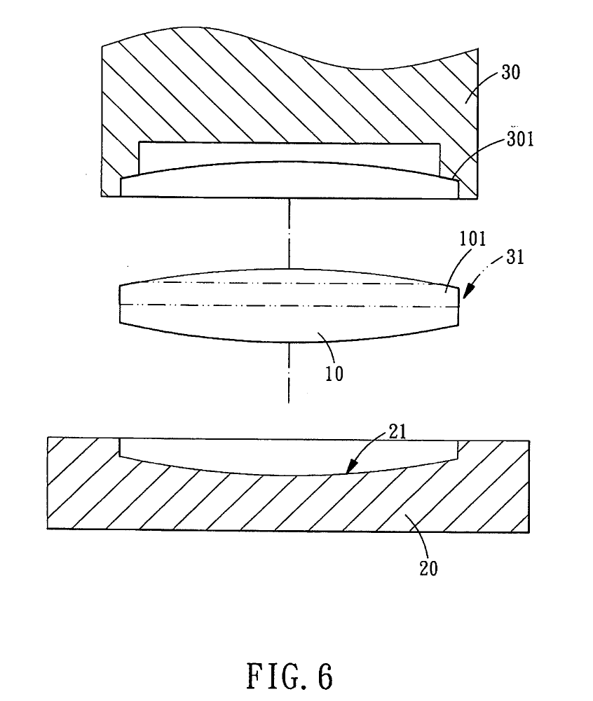

The foregoing, and additional objects, features and advantages of the present invention will become apparent from the following detailed description of preferred embodiments thereof, with reference to FIGS. 4-6.

An apparatus for inking a lens in accordance with the present invention comprises a stamping member 30 and a positioning member 20.

The positioning member 20 is defined in the top surface thereof with a plurality of positioning grooves 21 with which to hold a plurality of lenses 10 simultaneously, and an inactive area 101 of the respective lenses 10 protrudes out of the positioning grooves 21.

The stamping member 30 is a structure that can be controlled to extend and retract, and can move linearly back and forth relative to the lens 10 on the positioning member 20. On the surface of the stamping member 30 is formed an inking surface 301 coated with ink 31. The shape, the area, the location and the angle of the inking surface 301 fit the inactive area 101 of the lens 10 to be inked.

For a better understanding of the respective embodiments, the lens inking method of the respective embodiments is described as follows:

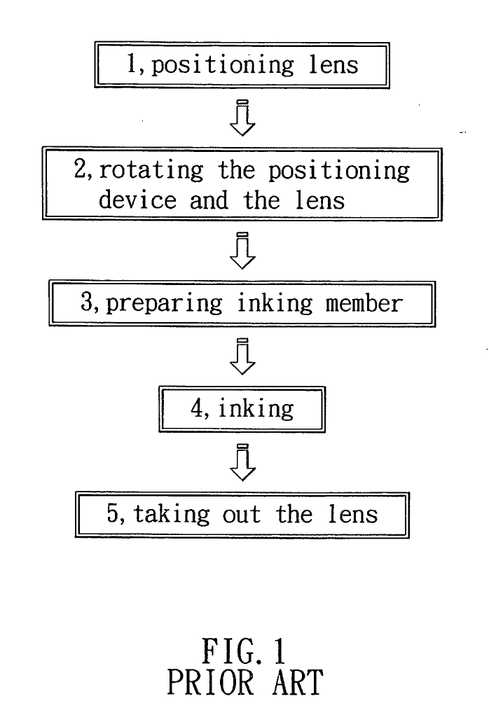

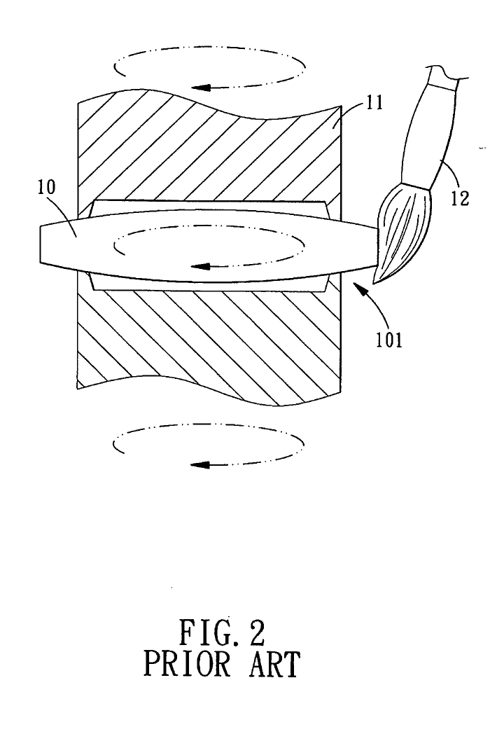

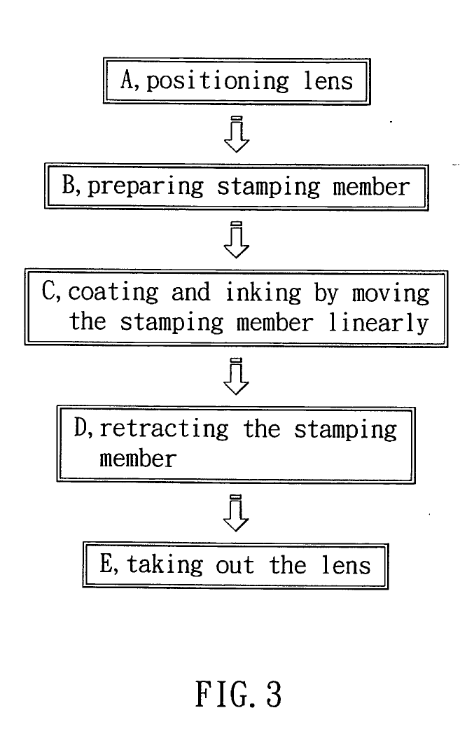

The lens inking method of the first embodiment is best illustrated by referring to FIGS. 1-6 and comprises the steps of:

A, positioning lens: positioning the lens 10 in the positioning groove 21 of the positioning member 20, and making the inactive area 101 of the lens 10 protrudes out of the positioning groove 21;

B, preparing stamping member: forming an inking surface 301 coated with ink 31 on the surface of the stamping member 30;

C, coating and inking by moving the stamping member linearly: moving the stamping member 30 linearly back and forth with respect to the lens 10 on the positioning member 20, and making the inking surface 301 contact the inactive area 101 of the lens 10, so as to apply the ink 31 of the inking surface 301 fully to the inactive area 101 of the lens 10.

D, retracting the stamping member: moving the stamping member 30 back to its original position;

E, taking out the lens: taking the lens 10 out of the positioning groove 21 of the positioning member 20.

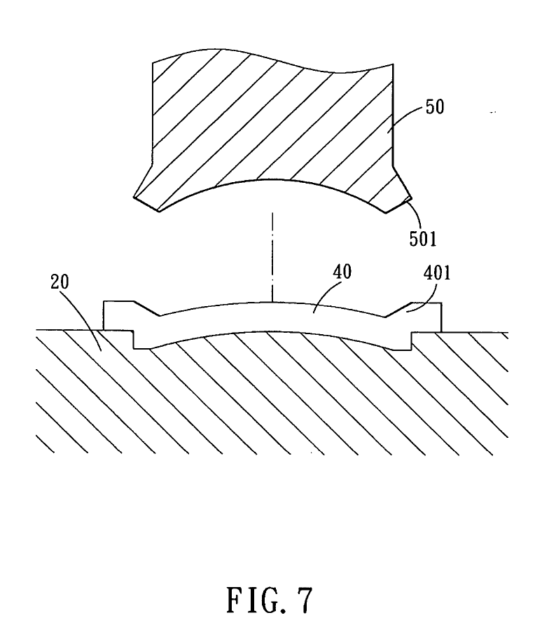

Referring to FIG. 7, a second embodiment of the present invention is illustrated, wherein the inactive area 401 is not located around the periphery of the lens 40. The shape, the area, the location and the angle of the stamping member 50 still fit the inactive area 101 of the lens 10 to be inked, thus the inking operation can be performed without being limited by the variety and the shape of the lens.

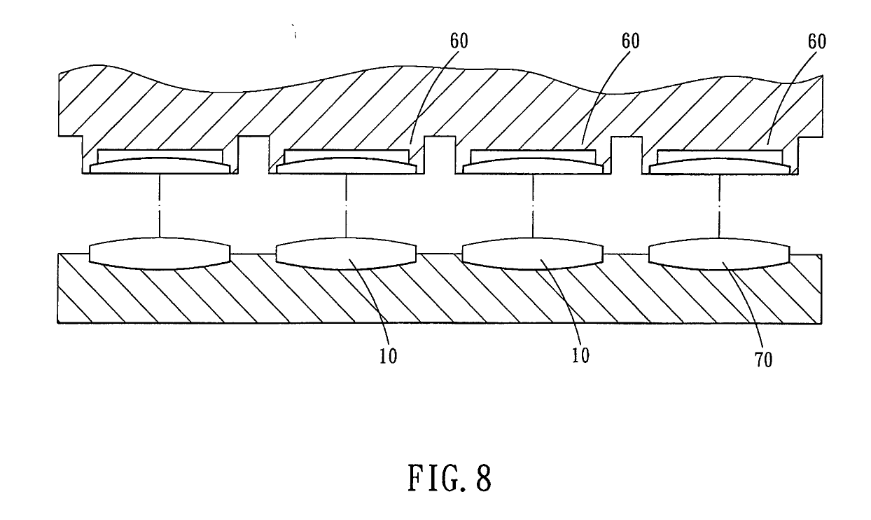

Referring further to FIG. 8, the step C of the present invention is to move a plurality of stamping members 60 linearly back and forth relative to the lenses 10 on the positioning member 70, and between the stamping members 60 and the positioning member 70 a plurality of lenses 10 can be inked synchronously. Therefore, it satisfies the requirement of mass production, effectively reducing the cost while improving the production efficiency.

As stated above, the present invention uses the following steps and apparatus to coat the lens with ink: A, positioning lens; B, preparing stamping member; C, coating and inking by moving the stamping member linearly; D, retracting the stamping member; and E, taking out the lens. The present invention comprises a stamping member and a positioning member. The stamping member moves linearly back and forth relative to the positioning member, on the surface of the stamping member is formed an inking surface coated with ink. The shape, the area, the location and the angle of the inking surface fit the inactive area of the lens to be inked. The inking surface of the stamping member can contact the inactive area of the lens, so as to enable the inactive area to be fully coated with ink. Therefore, the present invention is simply structured, has low cost, and satisfies the requirement of mass production.

While we have shown and described various embodiments in accordance with the present invention, it should be clear to those skilled in the art that further embodiments may be made without departing from the scope of the present invention.

What is claimed is:

1. A method for inking a lens comprising the steps of:
A, positioning lens: positioning a lens on a positioning member, and making an inactive area of the lens protrudes out of the positioning member;
B, preparing stamping member: forming an inking surface coated with ink on a surface of the stamping member;
C, coating and inking by moving the stamping member linearly: moving the stamping member linearly back and forth with respect to the lens on the positioning member, and making the inking surface contact the inactive area of the lens, so as to apply the ink on the inking surface to the inactive area of the lens;
D, retracting the stamping member: moving the stamping member back to ready position; and
E, taking out the lens: taking the lens out of the positioning member.

2. An apparatus for inking a lens comprising a stamping member and a positioning member;
the positioning member is defined with a positioning groove for holding a lens, and an inactive area of the lens protrudes out of the positioning grooves; and
the stamping member can move back and forth linearly relative to the lens on the positioning member, on a surface of the stamping member is formed an inking surface coated with ink, the shape, the area, the location and the angle of the inking surface fit the inactive area of the lens to be inked.

3. The apparatus for inking a lens as claimed in claim 2, wherein the positioning member is defined with a plurality of positioning grooves, and a plurality of stamping members are used to ink a plurality of lenses simultaneously.
